(19) United States
(12) Patent Application Publication
(10) Pub. No.: US 2014/0028560 A1
(43) Pub. Date: Jan. 30, 2014

(54) ELECTRONIC MOUSE WITH MODE SWITCHING FUNCTION

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: LEI LIU, Shenzhen (CN); GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/949,243

(22) Filed: Jul. 24, 2013

(30) Foreign Application Priority Data
Jul. 26, 2012 (CN) 201210260927X

(51) Int. Cl. G06F 3/0354; G06F 3/038

(52) U.S. Cl. CPC G06F 3/03543; G06F 3/0383
USPC 345/163

(57) ABSTRACT

An electronic mouse includes a main body. A left button, a right button, and a middle button are arranged on the main body. A control unit switches functions of the left button and the right button when a pressing time of the middle button is pressed for more than a predetermined time, thereby the control unit switches functions of the left button and the right button of the electronic mouse.

### BACKGROUND

1. Technical Field

The present disclosure relates to a electronic mouse having mode switching function according to hand preferences of users.

2. Description of Related Art

A electronic mouse is a basic input device for an electronic device, such as a personal computer and a notebook. The electronic mouse is usually designed for a right-handed user using default settings. This means left-handed users have to switch modes via a device manager, which can be complicated and differ from one electronic device to another.

Therefore, what is needed is a means to overcome the above described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is an isometric view of an electronic mouse having a mode switching function according to a first embodiment of present disclosure.

FIG. 2 is a detailed circuit diagram of the electronic mouse of FIG. 1.

### DETAILED DESCRIPTION

Reference will be made to the drawings to describe various embodiments.

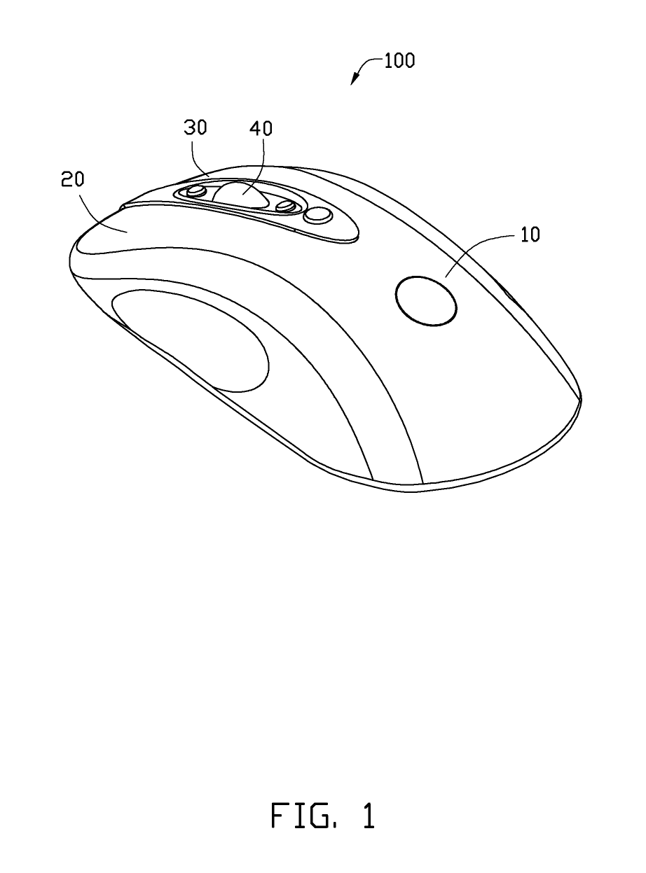

FIG. 1 is an isometric view of an electronic mouse 100 having a mode switching function according to a first embodiment of the present disclosure. The electronic mouse 100 includes a main body 10, a left button 20, a right button 30, and a middle button 40. The left button 20, the right button 30, and the middle button 40 are arranged on the main body 10, each closing a corresponding contact when pressed.

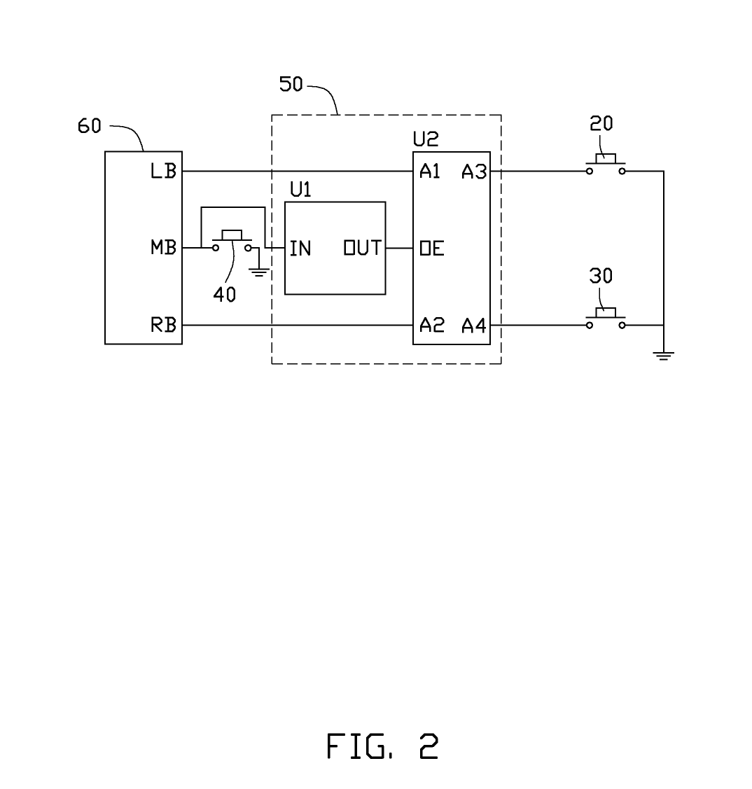

FIG. 2 is a detailed circuit diagram of the electronic mouse 100. The electronic mouse 100 includes a processor 60 arranged on a circuit board in the main body 10. The processor 60 senses operations of the left button 20, the right button 30, and the middle button 40 and outputs execution signals, corresponding to the operations, to an electronic device, such as personal computer. The processor 60 includes a first connection terminal LB, a second connection terminal RB, and a third connection terminal MB. The first connection terminal LB is electrically connected to the pressing switch of the left button 20. The second connection terminal RB is electrically connected to the pressing switch of the right button 30. The third connection terminal MB is electrically connected to the pressing switch of the middle button 40.

The electronic mouse 100 further includes a control unit 50. The control unit 50 is arranged on the circuit board. The control unit 50 is configured to sense operations applied on the left and right buttons to correspondingly generate the operation signals. The control unit 50 includes a timer U1 and a controller U2. The timer U1 detects a pressing time of the middle button 40, where the pressing time is a time of how long the middle button 40 is pressed. The controller U2 is configured to switch on functions of the left button 20 and the right button 30. When the pressing time of the middle button 40 is more than a predetermined time, the controller U2 switches connections between the processor 60 between the left and right button, thus the electronic mouse 100 switches functions of the left button 20 and the right button 30. In the embodiment, the predetermined time is set to be longer than a time to activate a trackball of the middle button 40. For example, the predetermined time can be three seconds.

The timer U1 includes an input pin IN and an output pin OUT. The input pin IN is electrically connected to the third connection terminal MB. The third connection terminal MB is further grounded via the middle button 40.

The controller U2 includes a first pin A1, a second pin A2, a third pin A3, a fourth pin A4, and an enable pin OE. The first pin A1 is electrically connected to the first connection terminal LB. The second pin A2 is electrically connected to the second connection terminal RB. The third pin A3 is grounded via the left button 20. The fourth pin A4 is also grounded via the right button 30. In the embodiment, the controller U2 is a select switch having dual channels.

In operation, when the left button 20 is pressed, the first connection terminal LB is grounded and the processor 60 generates a first execution signal corresponding to a function of the left button 20. When the right button 30 is pressed, the second connection terminal RB is grounded and the processor 60 generates a second execution signal corresponding to a function of the right button 30. When the pressing time of the middle button 40 is more than the predetermined time, the output pin OUT of the timer U1 outputs a control signal to the enable pin OE of the controller U2. Thus, the controller U2 controls the first connection terminal LB to connect to the right button 30 via the fourth pin A4 and the second connection terminal RB to connect to the left button 20 via the third pin A3. Thus, when the left button 20 is pressed, the processor 60 generates the second execution signal corresponding to the function of the right button 30. When the right button 30 is pressed, the processor 60 generates the first execution signal corresponding to the function of the left button 20.

When the pressing time of the middle button 40 is more than the predetermined time again, the controller 60 switches functions of the left button 20 and the right button 30.

In summary, the electronic mouse 100 can shift functions of the left button 20 and the right button 30 when the pressing time of the middle button 40 is more than the predetermined time, which simplifies functions of the electronic mouse 100.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. An electronic mouse, comprising:
a main body,
a left button, a right button, and a middle button arranged on the main body; and
a control unit detecting a pressing time of an operation applied on the middle button, and switching functions of the left button and the right button of the electronic mouse when the pressing time exceeds a predetermined time.

2. The electronic mouse of claim 1, wherein the control unit comprises a timer detecting the pressing time of the middle button; when the pressing time exceeds the predetermined time, the timer outputs a control signal.

3. The electronic mouse of claim 2, wherein the timer comprises an input pin and an output pin, the input pin is electrically connected to the middle button, and the output pin outputs the control signal.

4. The electronic mouse of claim 2, wherein the control unit further comprises a controller switching functions of the left button and the right button according to the control signal.

5. The electronic mouse of claim 4, further comprising a processor responding to an operation action applied on the left button, the right button, and the middle button and outputting corresponding execution signals to an electronic device connected with the electronic mouse.

6. The electronic mouse of claim 5, wherein the processor comprises a first connection terminal, a second connection terminal, and a third connection terminal, the controller comprises a first pin, a second pin, a third pin, a fourth pin, and an enable pin for receiving the control signal generated by the timer, the first pin is electrically connected to the first connection terminal, the second pin is electrically connected to the second connection terminal, the third pin is grounded via the left button, and the fourth pin is grounded via the right button.

7. The electronic mouse of claim 6, wherein the controller is a selected switch, and when the timer generates the control signal, the enable pin of the controller receives the control signal, and the control signal causes the third pin is connected to the second pin and is disconnected from the first pin, and the fourth pin is connected to the first pin and is disconnected to the second pin.

8. The electronic mouse of claim 7, wherein when the enable pin of the controller fails to receive the control signal, and the control signal causes the third pin is connected to the first pin and is disconnected to the second pin, and the fourth pin is connected to the second pin and is disconnected to the first pin.

9. The electronic mouse of claim 1, wherein the middle button is pressed for more than the predetermined time, the output pin of the timer outputs a control signal to the enable pin of the controller, and the controller controls the first connection terminal connects to the right button via the fourth pin and the second connection terminal connects to the left button via the third pin.

10. A electronic mouse having a left button, a right button, and a middle button, the electronic mouse comprising;
a processor detecting an operation action applied on the left button, the right button, and the middle button and outputting corresponding execution signals; the processor comprising a first connection terminal, a second connection terminal and a third connection terminal, wherein the processor generates a left-button execution signal when the first connection terminal is loaded with operation signals, generates a right-button execution signal when the third connection terminal receives the operation signals, and generates a middle-button execution signal when the second connection terminal is applied with the operation signals; and
a control unit configured to sense operations applied on the left and right buttons to correspondingly generate the operation signals, the control unit further comprising a first pin connected to the first connection terminal, a second pin connected to the third connection terminal, a third pin connected to the left button and a fourth pin connected to the second button;
wherein the control unit further detects a pressing time applied on the middle button and generates a control signal when the pressing time exceeds a predetermined time to the second connection terminal, and when the second connection terminal receives the control signal, the control unit makes the first pin to be connected with the fourth pin and disconnected from the third pin to receive the operation signals generated from the right button, and makes the second pin to be connected with the third pin and disconnected from the fourth pin to receive the operation signals generated from the left button.

11. The electronic mouse of claim 10, wherein the control unit comprises a timer detecting a pressing time of the middle button and when the pressing time exceeds the predetermined time, the timer outputs the control signal.

12. The electronic mouse of claim 11, wherein the timer comprises an input pin and an output pin, the input pin is electrically connected to the middle button, and the output pin outputs the control signal.

13. The electronic mouse of claim 12, wherein the control unit is a selected switch including an enable pin connected the output pin of the timer, and when the enable pin receives the control signal, the control unit controls that the first pin changes to be connected to the fourth pin from connecting to the third pin, and the second pin changes to be connected to the third pin from connecting to the fourth pin.

14. The electronic mouse of claim 10, wherein when the second connection terminal receives the operation signal, the processor generates the middle-button function signal.

15. The electronic mouse of claim 10, wherein the middle button is pressed for more than the predetermined time, the output pin of the timer outputs a control signal to the enable pin of the controller, and the controller controls the first connection terminal connects to the right button via the fourth pin and the second connection terminal connects to the left button via the third pin.
